(19) United States
(12) Patent Application Publication
(10) Pub. No.: US 2010/0304736 A1
(43) Pub. Date: Dec. 2, 2010

(54) Method and apparatus to enable high availability UMTS radio access networks by dynamically moving Node B links among RNCs

(76) Inventors: Kannan T. Konda, Aurora, IL (US); Sundar R. Sriram, Naperville, IL (US)

Correspondence Address: Carmen Patti Law Group, LLC, One N. LaSalle Street, 44th Floor, Chicago, IL, 60602, US

(21) Appl. No.: 12/455,451

(22) Filed: Jun. 2, 2009

(51) Int. Cl. H04W 24/00

(52) U.S. Cl. 455/424

(57) ABSTRACT

An apparatus in one example, wherein the apparatus comprises a link monitor, wherein the link monitor reconfigures link paths of a telecommunications network if links comprising a link route list are marked out of service.

### TECHNICAL FIELD

The invention relates generally to network management and more particularly to providing high availability UMTS radio access through link management.

### BACKGROUND

Telecommunication service providers and subscribers rely heavily on network availability. Subscribers rely on network availability to make personal, business and emergency calls. Service providers rely on network availability as a source of revenue and as a basis for the quality of service provided to their subscribers. If a telecommunications network is unavailable subscribers will not be satisfied with the lack of service, and the service provider will lose current and may lose future sources of revenue. The longer a network is down, the more money a service provider can lose and the more dissatisfied customers typically become.

In some cases, a single node in a network may cause these service outages. The rest of a telecommunications network may be up and running, but the loss of a single node may cause service outages for a large portion of the network. To avoid long downtimes, service providers typically temporarily reconfigure a network in order to maintain service. This reconfiguration may entail detecting the outage manually, and manually moving a link or a group of links from an out of service network node to a peer network node that is able to provide service. Although a network node is down, the peer node may be available and able to provide services. When the out of service node is working again, the network may be reconfigured so that the links are moved from the peer node back to the original network node.

In one particular example, in a Universal Mobile Telecommunications System (UMTS) network, a radio network controller (RNC) may fail. A NodeB under an RNC may not be able to provide service even though the NodeB is up and running. One method of providing service to subscribers is to solely provide Global System for Mobile communications (GSM) service to subscribers using the failed network node. This, however, may cause an overload in the GSM portion of the network. Furthermore, if a GSM network is not overlaid with the failed UMTS network, there may be no network that can provide service and thus, there may be a complete network outage until the failed UMTS network is restored.

Another solution for providing service in response to the failure is to reconfigure the NodeB so that the NodeB links to a different RNC, which is up and running. The NodeB is able to provide service and the risk of overloading the GSM portion of the network is alleviated. A network operator typically detects a network outage manually and reconfigures a network manually. Detecting outages manually and moving links manually may take long periods of time, which lengthens system downtime. Further, moving links that have been moved to a peer node back to the original node, may also consume long periods of time, which lengthens system downtime.

### SUMMARY

The invention in one implementation encompasses an apparatus. An exemplary apparatus comprises a link monitor. The link monitor reconfigures link paths of a telecommunications network if links comprising a link route list are marked out of service.

Another implementation of the invention encompasses a method. An exemplary method comprises determining if a group of links comprising a link route list is marked out of service. The method further comprises, moving Iub links comprising the group of links to a reroute destination.

### DESCRIPTION OF THE DRAWINGS

Features of example implementations will become apparent from the description, the claims, and the accompanying drawings in which:

FIG. 1 is a representation of one implementation of an apparatus that comprises a UMTS network where the method and apparatus for moving NodeB links among RNCs may reside.

FIG. 2 is a representation of one implementation of an apparatus that comprises a UMTS network in which NodeB links are moved among RNCs.

FIG. 3 is a representation of a message flow representing handling alarm events in a method for moving NodeB links among RNCs.

FIG. 4 is a representation of a message flow representing handling clear alarm events in a method for moving NodeB links among RNCs.

### DETAILED DESCRIPTION

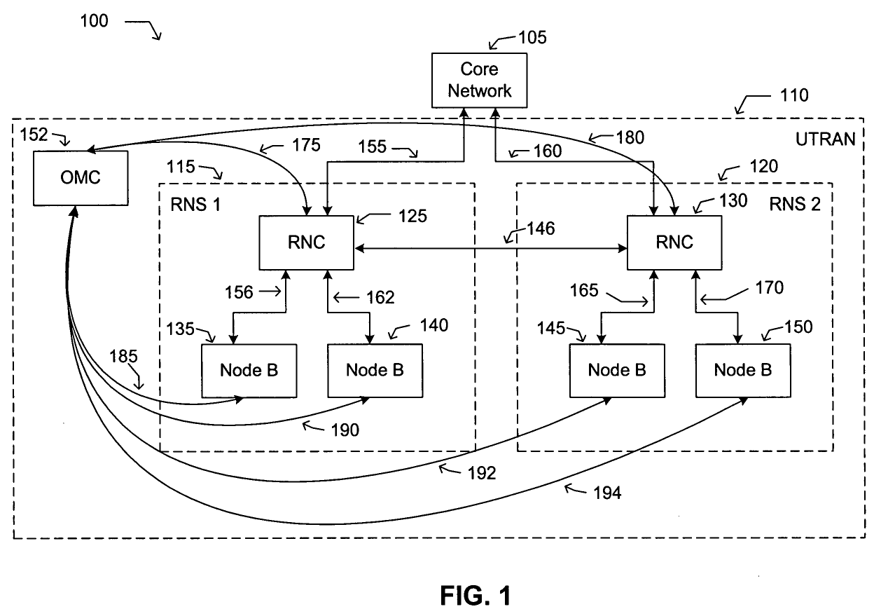

Turning to FIG. 1, an apparatus 100 in one embodiment comprises a UMTS network in which the method and apparatus to enable high availability UMTS radio access networks by dynamically moving NodeB links among RNCs may reside. The apparatus or network 100 comprises a core network 105 and an access network or UMTS Terrestrial Radio Access Network (UTRAN) 110. The core network 105 may be an Internet Protocol (IP) network, a telephony network or any other type of network that may provide switching, routing and transit for user traffic destined and emanating from the UTRAN 110. The UTRAN 110 may provide air interface access methods for User Equipment (UE) such as mobile handsets.

The UTRAN 110 may be further divided two radio network subsystems (RNS) 115, 120. In the embodiment depicted there are two RNSs 115, 120, however in other embodiments there may be fewer or more RNSs. Each RNS 115, 120 may be controlled by an RNC 125, 130. In a typical UMTS network an RNC may also control a number of NodeBs. The NodeBs may provide air interface access for UEs. In the embodiment depicted, a first RNC 125 controls a first NodeB 135 and a second NodeB 140. A second RNC 130 controls a third NodeB 145 and a fourth NodeB 150. The UTRAN 110 may further comprise an Operations and Maintenance Center (OMC) 152. The OMC 152 may provision and manage the first RNC 125, the second RNC 130, the first NodeB 135, the second NodeB 140, the third NodeB 145 and the fourth NodeB 150.

The core network 105 may be communicatively coupled with the RNCs 125, 130. The interface 155, 160 between the core network 105 and the RNCs 125, 130 may be an Iu interface or link. The Iu link 155, 160 may further comprise IuPS and IuCS links. An IuPS link may carry packet switched data from the UTRAN 110 to the core network 105, and the IuCS link may carry circuit switched data from the UTRAN 110 to the core network 105.

The RNCs 125, 130 may be communicatively coupled with the NodeBs 135, 140, 145, 150. The interfaces or links 156, 162, 165, 170 between the RNCs 125, 130 and the NodeBs 135, 140, 145, 150 may be Iub interfaces. The Iub links 156, 162, 165, 170 may comprise user voice, user data and information needed to control the air interface when a UE accesses the UTRAN 110. The RNCs 125, 130 may be communicatively coupled and communicate through an IuR interface 146.

The OMC 152 may be communicatively coupled with the first RNC 125 and the second RNC 130. The OMC 152 may communicate with the RNCs 125, 130 via an Itf-R interface or link 175, 180. The OMC 152 may also be communicatively coupled with the NodeBs 135, 140, 145, 150. The link or interface between the OMC 152 and the NodeBs 135, 140, 145, 150 may be an Itf-B link 185, 190, 192, 194. The Itf-R interface 175, 180 and the Itf-B interfaces 185, 190, 192, 194 may be proprietary interfaces.

During normal operations, a UE may access the UTRAN 110 via a NodeB. Data and voice may pass from the mobile through the NodeB and to the core network 105. For example, a subscriber using a mobile device may make a call, the call may access the network via the first NodeB 135. Data or voice involved in the call may be routed through the first NodeB 135 through the first RNC 125 and through to the core network 105. If the call is a voice call, the call may proceed over an IuCS link comprising the first Iu link 155. If the call is a data call the call may proceed over an IuPS link comprising the first Iu link 155.

There are times when the RNC 125 may fail in a manner such that the RNC 125 may not be able to handle calls. Even though the RNC 125 may be in a failure state, the NodeBs 135, 140 serving the RNC 125 may still be able to handle calls, but because the RNC 125 is down, the RNC 125 may not be able to pass any calls though to the core network 105. At this point, the NodeBs 135, 140 are unable to provide service because the RNC 125 is in a failure state. A solution to this problem is to route the calls through a different RNC that may be connected to the UTRAN 110. The management and configuration of links that would make this possible may be done through the OMC 152.

The OMC 152, as described earlier, may provision and manage links of one or more RNCs and the NodeBs serving one or more RNCs. Thus, as depicted in FIG. 1, the OMC 152 may provision and manage the RNCs 125, 130 and NodeBs 135, 140, 145, 150. In the process of managing links, the OMC 152 may receive different events from the nodes 125, 130, 135, 140, 145, 150 comprising the UTRAN 110. Included in these events are alarms that may indicate that a link has gone out of service and an event that indicates that a link has gone back in service. The OMC 152 may also send commands to the nodes 125, 130, 135, 140, 145, 150 including commands to move a link from one RNC to another RNC.

For example, the first NodeB 135 may send an event to the OMC 152 that is an alarm which indicates that the first Iub 156 is out of service (OOS). One of ordinary skill in the art will readily appreciate that the OOS alarm may indicate that the link is OOS at the NodeB 135 end of the link, or that the link is OOS at the RNC 125 end of the link, or that the link is OOS in some other manner. If the first Iub link 156 is OOS, an alarm may register at the OMC 152 and an operator monitoring the OMC 152 may take appropriate actions. In some cases, these actions may entail reconfiguring or rerouting the link 156 through the second RNC 130. Once the link monitor reroutes the link 156, voice and data traffic may be able to flow through the first NodeB 135 and the second RNC 130 to the core network 105. Thus, even though first RNC 125 may not be able to handle data and voice traffic via the Iub link 156, the first NodeB 135 may still be able to provide service by rerouting the first Iub link 156 so that the link 156 is in communication with the second RNC 130.

In another failure scenario, the first RNC 125 may have a catastrophic failure that prevents the first RNC 125 from providing voice and data service. In such a failure scenario, the first NodeB 135 and the second NodeB 140 may communicate alarms to the first OMC 152 that indicates that the far end of the Iub links 156, 162 (i.e., the end of the IuB link associated with the first RNC 125) are OOS. Furthermore, the OMC 152 may receive alarms that indicate that the Iu link 155 is also down. A failure in which all the Iub links of an RNC are down and the Iu links of an RNC are down, may indicate an RNC is in a state of catastrophic failure, which prevents the RNC from providing voice and data service to the NodeBs that it serves. Thus, the NodeBs under this RNC may not be able to provide UMTS subscriber service. In this instance, to provide service to subscribers trying to access a network via NodeBs under a failed RNC, Iub links that are routed through the failed RNC may have to be routed through a different RNC. In FIG. 1, if the first RNC 125 is in catastrophic failure, the first Iub link 156 and the second Iub link 162 may have to be rerouted through the second RNC 130.

As previously mentioned, an event being communicated to the OMC 152 may result in an alarm being indicated at the OMC 152. The alarm indication may take the form of a message being displayed or printed out at a monitor. The alarm, however, may also be processed by an application before it is printed out. In an embodiment, a link monitor application may be running on the OMC 152. In other embodiments the link monitor may reside in other nodes of the network. The link monitor may be software, firmware, hardware or any other type of executable entity that may be run on an OMC or any other node in a telecommunications network. The link monitor may receive and process events concerning the Iu links 155, 160 and the Iub links 156, 162, 165, 170 that are received by the OMC 152.

The OMC 152 may also be configured with tables that comprise a list of the different nodes and links that comprise the UTRAN 110. An exemplary table comprising the OMC 152 may be a link route list. In an embodiment, the link route list may reside on the OMC. In other embodiments, the link route list may reside on other nodes in the network 100 and accessed remotely. In an embodiment, the link route list is software. In other embodiments the link route list may be firmware, hardware or any other type of computing media that may be able to store a representation of a table or list. The link route list of the OMC 152 may be comprised of entries of one or more of the Iu links 155, 160 and Iub links 156, 162, 165, 170. The link route list may also comprise a state that is associated with each link comprising the link route list. Thus, for example, the Iu link 155 may be in an in service state, which indicates that the link is up and handling voice and data traffic. The link route list may be configurable by a service provider and may comprise any number of Iu and Iub links of a telecommunications network. Thus, a service provider may configure the link route list of the OMC 152 with the Iub links 156, 162, 165, 170 and Iu links 155, 160. The link route list may also make use of data such as a Network Service Access Point (NSAP) address, and cell and neighbor relation information.

As the link monitor receives events, the link monitor may determine an event type. The event types may include a link alarm, clear alarm, or some other event that is associated with a link. For example, if the event is a link alarm, the link monitor may set an indicator associated with the link that indicates that the link is out of service. If the event is a clear alarm, the link monitor may set an indicator associated with the link indicating that the alarm is cleared and the link is ready to provide voice and data service. Still further, if a link is rerouted, the link monitory may set an indicator associated with the link indicating that the link is rerouted.

As previously described, an operator may be able to manually move links from one node to another. Thus, an operator may be able to move one or all the Iub links 156, 162 under the first RNC 125 to the second RNC 130. The link monitor of the OMC 152 may also be configured to move links from one node to another in a telecommunications network. Thus, the link monitor may be configured such that the link monitor can move one or all the Iub links 156, 162 under the first RNC 125 to the second RNC 130 and vice-versa.

In an embodiment, a reroute destination is associated with a link comprising the link route list. In still another embodiment, a reroute destination is associated with a group of links comprising the link route list. The reroute destination may be another node comprising the network 100. Thus, the reroute destination of Iub link 156 may be the second RNC 130. When a link is rerouted, the link may be marked as rerouted in the link route list.

In one embodiment, if an Iub link comprising the link route list is out of service, the Iub link is rerouted through a different node in the network. In another embodiment, all the links comprising the link route list must be out of service before Iub links are rerouted. In still another embodiment, the link route list may be comprised of groups of links. If all the links comprising the group are out of service, the links comprising the group are rerouted.

As the link monitor receives events, the link monitor may update the link route list. In an embodiment, if a link is marked out of service at the far end (an RNC end) the link is reconfigured or rerouted to a reroute destination. For example, if the link list comprises the first Iub link 156 and the reroute destination for the first Iub link 156 is the second RNC 130, the link monitor may reroute the Iub link 156 through the second RNC 130 if the link 156 is marked out of service. In another embodiment the link route list may comprise all data/voice links 156, 162, 155 associated with the RNC 125 depicted in FIG. 1. If all the links 156, 162, 155 are marked OOS, the link monitor may reroute all the Iub links comprising the link route list. If the reroute destination of the first Iub link 156 and the second Iub link 162 is the second RNC 130, the link monitor may reroute all Iub links 156, 162 through the second RNC 130.

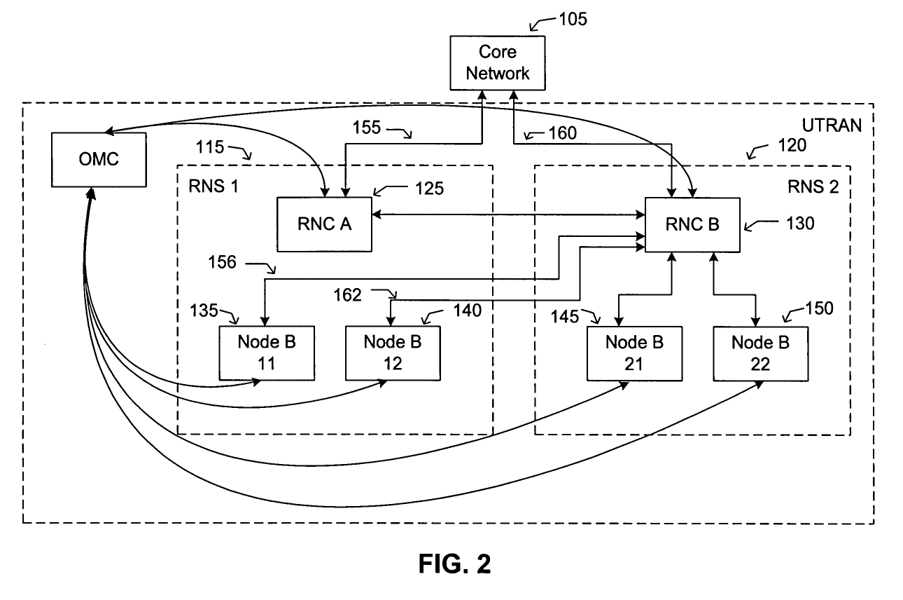

Turning now to FIG. 2, which depicts the system 100 of FIG. 1 after the first Iub link 156 and the second Iub link 162 are rerouted through the second RNC 130. As seen in FIG. 2, the Iub links 156, 162 that previously were communicatively coupled with first RNC 125 are now communicatively coupled with the second NodeB 130. Voice and data traffic may now pass through the first NodeB 135 and second NodeB 140 through the second RNC 130 to the core network. Thus, if the first RNC 125 is in a catastrophic failure, the first NodeB 135 and second NodeB 140 may continue to provide services via the second RNC 130.

Although the RNCs 125, 130 are depicted in separate RNSs 115, 120, the RNCs 125, 130 may reside in a same RNS. Also, although in the embodiment depicted the link monitor moves Iub links 135, 140 from the first RNC 125 to the second RNC 130, the link monitor may also be move Iub links from a first port to a second port on an RNC. In other embodiments, the link monitor may also be configured to move the Iu links 155, 160 from the first RNC 125 to the second RNC 130. Motivations may vary for moving Iub links within an RNC, or Iu links from one RNC to another RNC. For example, network cards of an RNC may serve certain groups of links and, thus, if a network card fails, the link monitor may be configured to move a link from a port on a first card to a port on a second card. Or, a group of Iub or Iu links may be served by an asynchronous transfer mode (ATM) backbone and if the backbone fails the link monitor may be configured to route around this failure.

The link route list may further comprise a restore destination that is associated with each entry in the list. The restore destination may comprise the destination, i.e. the node, to which a link should be restored after an alarm clears. As the link monitor receives events, the link monitor may determine if an event is a clear link alarm event. If the link monitor receives a clear link alarm event, the link monitor may mark a link associated with the event as in service. For example, if the event that caused the RNC 125 to stop serving the first Iub link 156 clears, the link monitor may receive a clear link alarm event associated with the first Iub link 156. When the link monitor receives the clear link alarm event associated with the first Iub link 156, the link monitor may mark the first Iub link 156 as in service.

In one embodiment, if a link is marked as rerouted, when the rerouted link is marked as in service, the link monitor may restore or move the link to the restore destination. Thus, if the first Iub link 156 is marked as rerouted and the link monitor receives an event indicating the alarm is cleared at the first RNC 125, the link monitor may restore the Iub link 156 to the first RNC 125.

In other embodiments, the link route list may be configured to indicate that links may be restored only after a group of rerouted links has returned to in service. For example, if the Iub links 156, 162 are rerouted through the second RNC 130 and the NodeBs 135, 140 send the link monitor events that indicate the alarms that caused the reroute have cleared, the links 156, 162 may then be restored to the first RNC 125. If the links 156, 162 are rerouted so that the links 156, 162 are configured as show in FIG. 2, after the links 156, 162 are restored, the links may be configured as shown in FIG. 1. In still another embodiment, the link monitor restores links only during certain hours. Thus, the link monitor may determine the time of day before restoring links. If the time of day is a peak hour for wireless service, the link monitor may set an indicator or timer as a reminder to restore the links at an off-peak hour. If the time of day is an off-peak hour, such as, three A.M., the link monitor may restore the links immediately.

The apparatus 100 and link monitor in one example comprises a plurality of components such as one or more of electronic components, hardware components, and computer software components. A number of such components can be combined or divided in the apparatus 100. An example component of the link monitor and apparatus 100 employs and/or comprises a set and/or series of computer instructions written in or implemented with any of a number of programming languages, as will be appreciated by those skilled in the art. The apparatus 100 in one example comprises any (e.g., horizontal, oblique, or vertical) orientation, with the description and figures herein illustrating one example orientation of the apparatus 100, for explanatory purposes.

The apparatus 100 and link monitor in one example employs one or more computer-readable signal-bearing media. The computer-readable signal-bearing media store software, firmware and/or assembly language for performing one or more portions of one or more implementations. Examples of a computer-readable signal-bearing medium for the apparatus 100 comprise the recordable data storage medium of the link monitor comprising the OMC. The computer-readable signal-bearing medium for the link monitor and apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

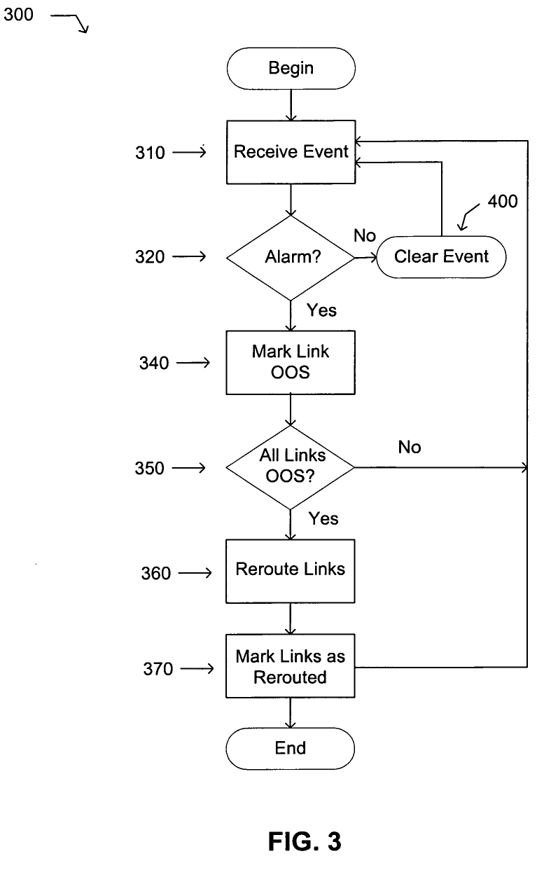

Turning to FIG. 3, which depicts one embodiment of a method 300 enabling high availability UMTS radio access networks by dynamically moving NodeB links among RNCs. In one embodiment, the link monitor described in relation to FIG. 1 and FIG. 2 may perform the method 300.

In step 310, a link event is received. If the event 320 is an alarm, the link associated with the alarm is marked OOS in the link route list 340. As previously described, in an embodiment, the link route list may be configured in groups and if all the links comprising a group are marked OOS 350, the link monitor may reroute the OOS Iub links 360. Alternatively, if all the link comprising the link monitor list are marked OOS, the link monitor may reroute Iub links comprising the link monitor list to a reroute destination. Still further, the link monitor may be configured to reroute a link comprising the link monitor list if the link is marked OOS. If an IuB link or links are rerouted, the link or links are marked as rerouted 370.

In another embodiment, if an Iub link is marked OOS 340, the link may be rerouted 360 even if the remaining links comprising a link group or link route list are not OOS. After the link is marked as rerouted 370, the link monitor continues to receive events 310. If the link monitor receives an event 310 that is not an alarm 320, the clear event method 400 is invoked.

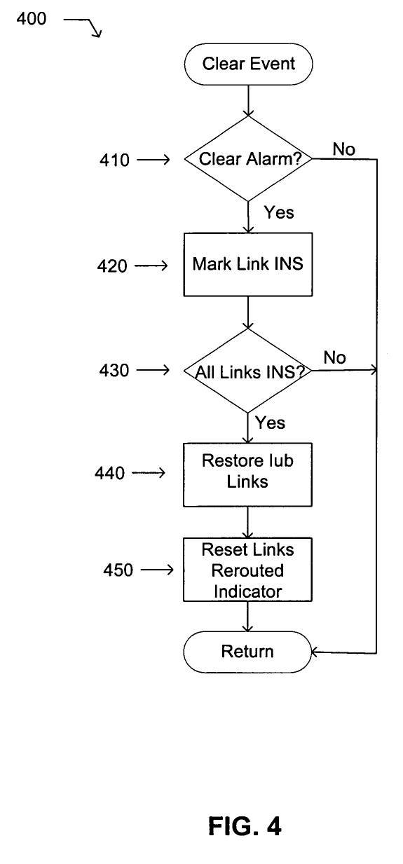

Turning now to FIG. 4, which depicts an exemplary method that may be executed when handling a clear alarm event. The method depicted in FIG. 4 may be performed by the link monitor. If the event is not a clear alarm 410, the method 400 returns. If the event is a clear alarm event 410, the link associated with the clear alarm may be marked in service 420.

If all the links comprising the link route list, or all the links comprising a group of links comprising the link route list are not in service 430, the method returns. If all the links comprising the link route list, or all the links comprising a group of links comprising the link route list are in service 430, the links comprising the list or group are restored 440, and the links rerouted indicator associated with a link or group of links is cleared 450.

In an embodiment, the links are restored 440 only during certain hours. Thus, the link monitor may determine the time of day before restoring links. If the time of day is a peak time for wireless service, the link monitor may set an indicator or timer as a reminder to restore the links at an off-peak hour. If the time of day is an off-peak hour, such as, three A.M., the link monitor may restore the links immediately.

In still another embodiment, if an Iub link is marked in service 420, the link may be restored regardless of whether all the links comprising a group of links or the link monitor list are restored. Thus, in this embodiment, the links may be restored one at a time as a clear link alarm event is received for each link.

The steps or operations described herein are merely exemplary. There may be many variations to these steps or operations without departing from the spirit of the described embodiments. For instance, the steps may be performed in a differing order, or steps may be added, deleted, or modified.

Although example implementations of the disclosed embodiments have been depicted and described in detail herein, it will be apparent to those skilled in the relevant art that various modifications, additions, substitutions, and the like can be made without departing from the spirit of the disclosed embodiments and these are therefore considered to be within the scope of the invention as defined in the following claims.

We claim:

1. An apparatus, comprising:
a link monitor;
the link monitor for reconfiguring link paths of a telecommunications network if links comprising a link route list are marked out of service.

2. The apparatus of claim 1 wherein the link monitor:
resides on an Operations and Maintenance Centre (OMC) and is configured to:
receive Iu link alarms,
maintain a link route list where the link route list comprises at least one link, and
reconfigure an Iub link path if links comprising the link route list are marked out of service.

3. The apparatus of claim 2, further comprising at least one Radio Network Controller (RNC), at least one NodeB, and a core network wherein:
the OMC is communicatively coupled with the at least one RNC and the OMC is communicatively coupled with the at least one NodeB;
the at least one NodeB is communicatively coupled with the at least one RNC via at least one Iub link;
the at least one RNC is communicatively coupled with the core network via at least one Iu link wherein an Iu link further comprises at least one of an IuCS link and an IuPS link; and
the OMC manages the at least one NodeB and the at least one RNC, wherein the link monitor reroutes at least one Iub link from a first RNC to a second RNC if links comprising the link route list are out of service.

4. The apparatus of claim 3 further comprising a first RNS and a second RNS, wherein the link monitor directs movement of at the least one Iub link from a first RNC residing in a first RNS and to a second RNC residing in a second RNS if links comprising the link monitor list are out of service.

5. The apparatus of claim 4, wherein the link route list comprises a link and a reroute destination is associated with the link and restore destination is associated with the link.

6. The apparatus of claim 4, wherein the link route list comprises at least one Iub link, at least one IuPS link and at least one IuCS link, wherein if all the links comprising the link route list are out of service, the link monitor directs movement of Iub links comprising the link route list from a first RNC to a second RNC.

7. The apparatus of claim 4, wherein a first RNC is associated with a plurality of Iub links, a plurality of IuCS links and a plurality of IuPS links, the link route list comprises the plurality of Iub links, the plurality of IuCS links and the plurality of IuPS links, and if an Iub link comprising the link route is marked Out Of Service (OOS), the link monitor directs rerouting the link to a reroute destination associated with the Iub link.

8. The apparatus of claim 7, wherein if the links comprising the link route list are marked in service and the links are rerouted the link monitor directs restoring the links by moving the links to the restore destination.

9. The apparatus of claim 8, wherein the link monitor directs restoring the links if the time of day is an off-peak period.

10. The apparatus of claim 8, wherein the link monitor sets a timer and directs restoring the links during an off-peak period if the links comprising the link route list are marked in service during a peak period.

11. The apparatus of claim 4, wherein the link route list comprises a group of links and if all the links comprising the group of links are marked out of service, the link monitor directs rerouting the Iub links comprising the group of links to a reroute destination.

12. A method comprising:
determining if a group of links comprising a link route list are marked out of service; and
directing movement of Iub links comprising the group of links to a reroute destination.

13. The method of claim 12 wherein the method is performed on an OMC and the link route list resides on the OMC.

14. The method of claim 13 further comprising receiving a link event wherein the link event is at least one of a link alarm and clear link alarm.

15. The method of claim 14 wherein if the link event is a link alarm, the method further comprising:
receiving at least one alarm associated with a link where the link is one of an Iub link and an Iu link, where the Iu link further comprises one of an IuPS link and an IuCS link;
marking the link out of service if the received alarm is associated with the link; and
marking the link in service if a clear alarm is received that is associated with the link.

16. The method of claim 15 wherein the group of links includes a first link, and if the first link is marked out of service, the first link is moved to a reroute destination.

17. The method of claim 16 wherein the group of links comprises a plurality of links, wherein if a link alarm is received for an Iub link the Iub link is marked out of service and the Iub link is moved to a reroute destination, wherein the plurality of links comprises at least one of an of Iub link, at least one of an IuCS link and at least one of an IuPS link.

18. The method of claim 16 wherein the group of links comprises a plurality of links wherein the plurality of links comprises at least one Iub link, at least one IuCS link and at least one IuPS link, and if all the links are marked out of service Iub links comprising the group of links are rerouted to a reroute destination.

19. The method of claim 16 wherein if a link comprising the group of links is marked as in service and the link is rerouted, the link is restored to a restore destination.

20. The method of claim 16 wherein if all the links comprising the link route list are marked in service and all the links are rerouted, all the links are restored to a restore destination.
